(19) United States
(12) Patent Application Publication
(10) Pub. No.: US 2025/0091838 A1
(43) Pub. Date: Mar. 20, 2025

(54) SYSTEM AND METHOD FOR PROVIDING GUIDED SERVICE SOLUTIONS TO ADDRESS COMPONENT FAULTS IN SYSTEMS FOR MOVING PEOPLE

(71) Applicant: OTIS ELEVATOR COMPANY, Farmington, CT (US)

(72) Inventors: Pradeep Miriyala, Hyderabad Telangana (IN); Srinivasarao Ladi, Hyderabad Telangana (IN)

(21) Appl. No.: 18/470,963

(22) Filed: Sep. 20, 2023

(51) Int. Cl. B66B 25/00

(52) U.S. Cl. CPC B66B 25/003; B66B 25/006

(57) ABSTRACT

Disclosed is a system for moving people, including: a component; and a processor configured to: receive a diagnostic message from a mobile device identifying a fault with the component; and execute a generative artificial intelligence (Gen-AI) model that identifies the component, the fault and generates service solution data for performing a service solution for addressing the fault for the component; and transmit the service solution data to the mobile device.

### BACKGROUND

The embodiments described herein are directed to systems for moving people, including but not limited to elevators, escalators and moving walkways, and more specifically to a system and method for providing guided service solutions to address component faults in such systems.

Mechanics may use software applications to troubleshoot faults. Messages from such applications may require a mechanic to have knowledge of a system for moving people to understand and resolve the faults. Such applications may also provide short descriptions of faults without providing information about how to address the faults.

### BRIEF SUMMARY

Disclosed is a system for moving people, including: a component; and a processor configured to: receive a diagnostic message from a mobile device identifying a fault with the component; and execute a generative artificial intelligence (Gen-AI) model that identifies the component, the fault and generates service solution data for performing a service solution for addressing the fault for the component; and transmit the service solution data to the mobile device.

In addition to one or more of the above aspects of the system, or as an alternate, the component is an elevator car, elevator machine, escalator or moving walkway.

In addition to one or more of the above aspects of the system, or as an alternate, the Gen-AI architecture is configured to identify the component from pairwise mapping of an image and text encoder matrix generated by applying component image descriptions to a text encoder of the Gen-AI architecture and applying component images to an image encoder of the Gen-AI architecture.

In addition to one or more of the above aspects of the system, or as an alternate, the diagnostic message includes a textual description of symptoms of the fault; and the Gen-AI architecture includes an encoder that extracts the component and the fault from the textual description.

In addition to one or more of the above aspects of the system, or as an alternate, the service solution data includes textual instructions and corresponding graphical instructions for performing the service solution.

In addition to one or more of the above aspects of the system, or as an alternate, the textual instructions includes a sequence of steps and the graphical instructions illustrate the sequence of steps as one or more of an image and an animation for performing each step in the sequence of steps.

In addition to one or more of the above aspects of the system, or as an alternate, the graphical instructions illustrate the sequence of steps as 3-D animations for performing each of the sequence of steps.

In addition to one or more of the above aspects of the system, or as an alternate, the Gen-AI architecture is configured to apply a text-to-text model to generate the textual instructions and apply a text-to-image model to generate the graphical instructions.

In addition to one or more of the above aspects of the system, or as an alternate, the processor is configured to train the Gen-AI architecture with training data from a database that includes: technical documentation and design specifications for the component; a service history data for the component, including prior faults and prior service solutions; and prior feedback data related to the prior service solutions, wherein after execution of the Gen-AI architecture to identify the service solution, the service history data is updated to include the service solution and feedback data for the service solution.

In addition to one or more of the above aspects of the system, or as an alternate, the service history data in the database grouped by geographic region.

Further disclosed is a method of addressing a fault of a component in a system for moving people, including: receiving a diagnostic message, from a mobile device, identifying the fault with the component; and executing a generative artificial intelligence (Gen-AI) model that identifies the component, the fault and generates service solution data for performing a service solution for addressing the fault for the component; and transmitting the service solution data to the mobile device.

In addition to one or more of the above aspects of the method, or as an alternate, the component is an elevator car, an elevator machine, an escalator or a moving walkway.

In addition to one or more of the above aspects of the method, or as an alternate, the method includes identifying the component from pairwise mapping of an image and text encoder matrix generated by applying component image descriptions to a text encoder of the Gen-AI architecture and applying component images to an image encoder of the Gen-AI architecture.

In addition to one or more of the above aspects of the method, or as an alternate, the diagnostic message includes a textual description of symptoms of the fault; and the method includes the Gen-AI architecture, extracting with an encoder, the component and the fault from the textual description within the diagnostic message.

In addition to one or more of the above aspects of the method, or as an alternate, the method includes including, in the service solution data, textual instructions and corresponding graphical instructions for performing the service solution.

In addition to one or more of the above aspects of the method, or as an alternate, the textual instructions includes a sequence of steps; and the method includes providing, with the graphical instructions, one or more of an image and an animation for performing each step in the sequence of steps.

In addition to one or more of the above aspects of the method, or as an alternate, the method includes providing, with the graphical instructions, 3-D animations for performing each of the sequence of steps.

In addition to one or more of the above aspects of the method, or as an alternate, the method includes applying, by the Gen-AI architecture, a text-to-text model to generate the textual instructions and a text-to-image model to generate the graphical instructions.

In addition to one or more of the above aspects of the method, or as an alternate, the method includes training the Gen-AI architecture with training data from a database that includes: technical documentation and design specifications for the component; a service history data for the component, including prior faults and prior service solutions; and prior feedback data related to the prior service solutions, wherein after execution of the Gen-AI architecture to identify the service solution, the method includes updating the service history data to include the service solution and feedback data for the service solution.

In addition to one or more of the above aspects of the method, or as an alternate, the method includes grouping the service history data in the database by geographic region.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 shows a technology ecosystem that executes a Gen-AI architecture for providing guided service solutions to address component faults;

FIG. 3 is a process map that shows pairwise mapping of component descriptions and images for utilization by the Gen-AI architecture to generate the service solutions from descriptions of the component and fault data;

FIG. 4 is another process map that shows additional details of utilized by the Gen-AI architecture to generate the service solution, including the utilization of a diffusion model and image decoder to generate images supporting the service solution;

FIG. 5 is another process map that shows additional details of utilizing the Gen-AI architecture to generate the service solution;

FIG. 6 is a flowchart showing a method for providing guided service solutions to address component faults utilizing a Gen-AI architecture; and

FIG. 7 is a flowchart showing a method of training the Gen-AI architecture.

### DETAILED DESCRIPTION

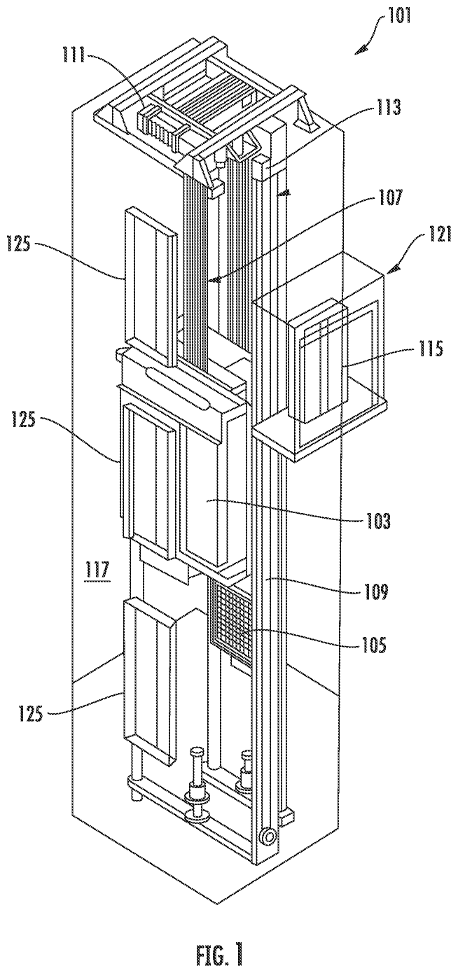

FIG. 1 is a perspective view of an elevator system 101 including an elevator car 103, a counterweight 105, a tension member 107, a guide rail (or rail system) 109, a machine (or machine system) 111, a position reference system 113, and an electronic elevator controller (controller) 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft (or hoistway) 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. It is to be appreciated that the controller 115 need not be in the controller room 121 but may be in the hoistway or other location in the elevator system. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

In other embodiments, the system comprises a conveyance system that moves passengers between floors and/or along a single floor. Such conveyance systems may include escalators, people movers including moving walkways, etc. Accordingly, embodiments described herein are not limited to elevator systems, such as that shown in FIG. 1.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., elevator cars equipped with friction wheels, pinch wheels or traction wheels). FIG. 1 is merely a non-limiting example presented for illustrative and explanatory purposes. As indicated, escalators and moving walkways are within the scope of the disclosure.

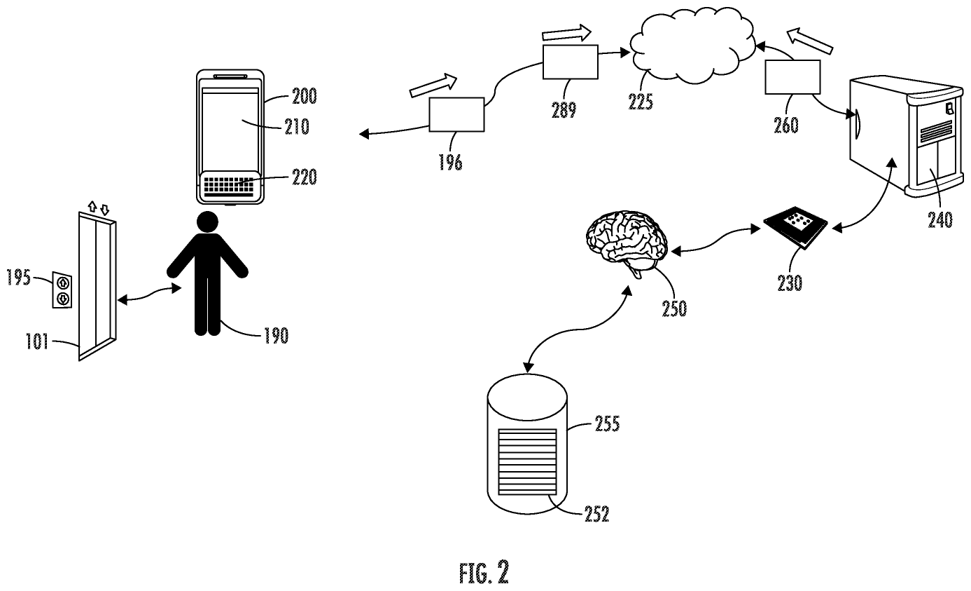

Turning to FIG. 2, in one embodiment, a mechanic 190 may identify a fault with a component 195 of the system 101 of FIG. 1, such as an elevator control, the elevator car 103 or machine 111, call buttons (as shown), etc., as nonlimiting examples. The mechanic 190 may have a cell phone 200 or other smart device with a screen 210 and keyboard 220 such as a virtual keyboard, touchscreen or implement for processing voice input.

The mechanic 190 may send, via the mobile device 200, a diagnostic message 196, identifying the component 195 and symptoms of the fault, in plain text, over a network 225 for processing on a processor 230 located on a local or remote server 240 or on the cloud. The diagnostic message 196 may also be generated automatically by a mobile application (or other applications running on edge devices) by processing the sensor data received from the elevator car. For example, the mobile application may receive sensor data and analyze issues and generate diagnostic messages in an automated fashion.

It is to be appreciated that the mechanic 190 may observe the fault or realize the fault exists based on sensor data, e.g., from sensors (e.g., speed and vibration sensors) onboard the elevator system 101. The processor 230 may include a generative artificial intelligence (Gen-AI) architecture 250 it may execute to extract from the diagnostic message 196 the identity of the component 195 and the fault. With the Gen-AI architecture 250, processor 230 may generate service solution data (or generally, a service solution) 260. The service solution data 260 may be transmitted back to the mobile device 200 for guiding the mechanic 190 to address the fault with the component 195. The solution 260 may include text and images, such as 3-D animations. This enables a mechanic 190 with relatively little knowledge of elevator systems 101 to address the fault, saving time and resources.

The Gen-AI architecture 250 may be trained with training data 252 from a database 255 that includes technical documentation and design specifications for the component 195. The training data 252 may also include service history data for the component 195. The service history data may include prior faults and prior service solutions for the component 195. The training data 252 may also include prior feedback data, provided by the mechanic 190 or other mechanics, related to the prior service solutions for the component 195. The service history in the database 255 may be grouped by geographic region, e.g., because different regions may have local configurations of the component 195 due to utilization customs or other local influences. After execution of the Gen-AI architecture 250 to identify the service solution 260, the service history data is updated to include the service solution 260 and current feedback data 289 from the mechanic 190 for fine tuning the Gen-AI architecture 250.

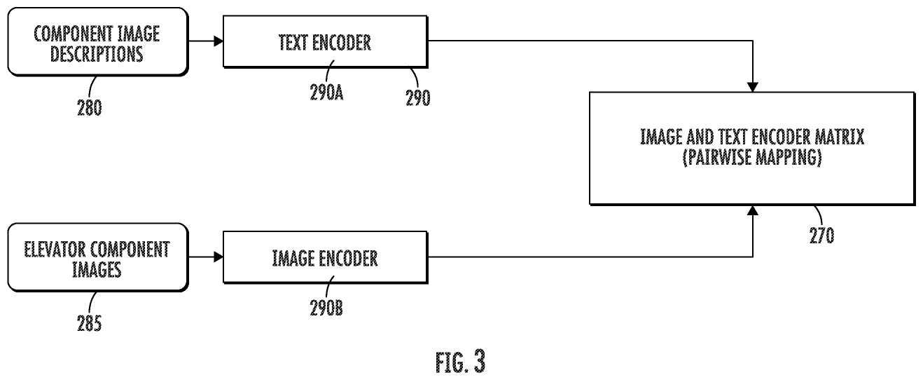

More specifically, as shown in FIG. 3, the Gen-AI architecture 250 may identify the component 195 from a pairwise mapping 270 of an image and text encoder matrix. The mapping 270 may be generated by applying component image descriptions 280 to a text encoder 290A (encoders are generally referred to as 290) of the Gen-AI architecture 250 and applying component images 285 to an image encoder 290B of the Gen-AI architecture 250.

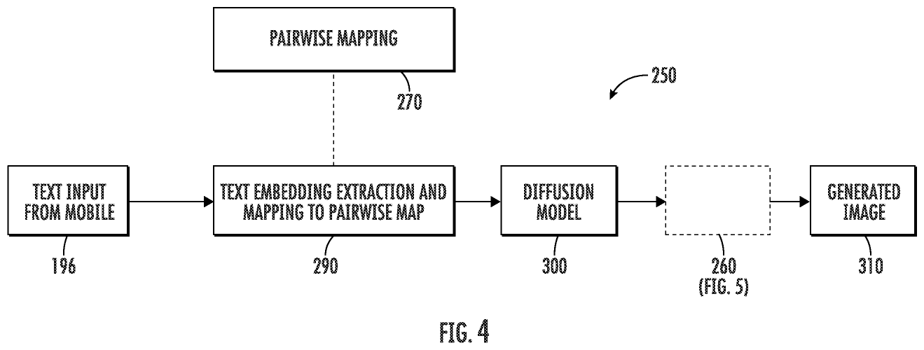

As shown in FIG. 4, applying the pairwise mapping 270, the disclosed Gen-AI architecture 250 may utilize the encoder 290 for extracting text input 196 from the mobile device 200 and identifying the component 195 and fault. Output from the encoder 290 may be fed to a diffusion model 300 that is tailored for use with elevators, escalators and moving walkways. Such model may include DALL-E developed by OpenAI, to generate the service solution 260. Firefly by Adobe. (https://www.adobe.com/sensei/generative-ai/firefly.html); Dreamstudio Stable Diffusion Model by Stability.AI (https://github.com/Stability-AI/stablediffusion); Midjourney Image generator model by Midjourney (https://www.midjourney.com/home/?callbackUrl-% 2Fapp%2F); and Image Creator by Microsoft Bing (https://www.bing.com/create?toWww=1&redig=E0276A5023D243858F49FAA1A5 A4A8F5). The service solution 260 is then processed by an image decoder 310 to produce a generated image 320 that may be displayed on the mobile device 200 (FIG. 2).

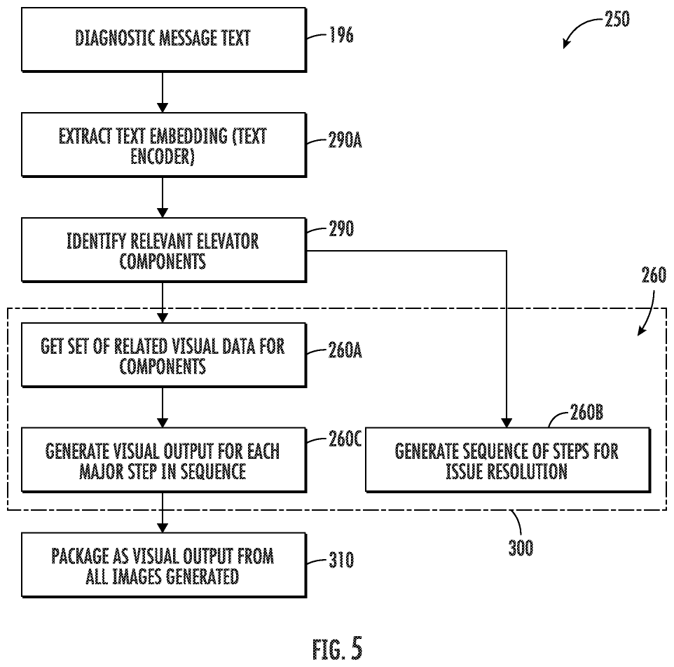

More specifically, as shown in FIG. 5, the Gen-AI architecture 250 receives the diagnostic message 196 and extracts the embedded text with the text encoder 290A. The encoder 290 is utilized for identifying the component 195 as shown in FIG. 3. The service solution 260 is then generated, e.g., with the diffusion model 300. For example, a set of visual data 260A is obtained for the component 195. A sequence of steps for fault (or issue) resolution 260B is generated. This may be achieved by applying a text-to-text model based on Large Language Model Structures, e.g., utilizing ChatGPT as a nonlimiting example. Visual output 260C is generated for each step, e.g., utilizing a text-to-image model. The solution data 260 continues to be generated for each step on the sequence of steps. Then the Gen-AI architecture 250 generates a package of all images as visual output, e.g., as shown with block 260 (FIG. 5).

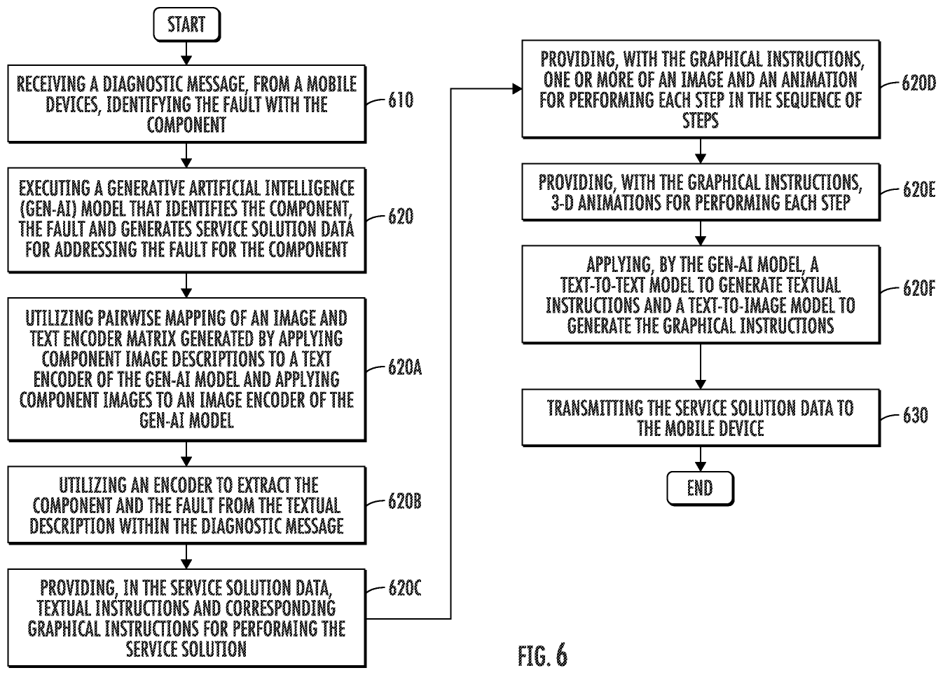

Turning to FIG. 6, a flowchart shows a method of providing guided service solutions to address elevator component faults. As shown in block 610 the method includes receiving a diagnostic message, from a mobile device 200, identifying the fault with the component 195 of the elevator system 101. As shown in block 620 the method includes executing a generative artificial intelligence (Gen-AI) architecture 250 that identifies the component 195, the fault and generates service solution data 260 for addressing the fault for the component 295.

As shown in block 620A, identifying the component (block 620) includes utilizing a pairwise mapping 270 of an image and text encoder matrix generated by applying component image descriptions 280 to a text encoder 290 of the Gen-AI architecture 250 and applying component images 285 to an image encoder 290B of the Gen-AI architecture 250 (FIG. 3). As shown in block 620B identifying the component and fault (block 620) includes utilizing an encoder 290 to extract the component 195 and the fault from the textual description within the diagnostic message 160 (FIG. 4).

As shown in block 620C, generating the service solution data (block 620) includes providing, in the service solution data 260, textual instructions and corresponding graphical instructions for performing the service solution (FIG. 5). As shown in block 620D, generating the service solution data (block 620) further includes providing, with the graphical instructions, one or more of an image and an animation for performing each step in the sequence of steps. As shown in block 620E, generating the service solution data (block 620) further includes providing, with the graphical instructions, 3-D animations for performing each of the sequence of steps. Alternatively the images and animations may be provided for steps having a particular importance, such as provided by weighting. As shown in block 620F, generating the service solution data (block 620) further includes applying, by the Gen-AI architecture 250, a text-to-text model to generate the textual instructions and a text-to-video/animation model to generate the graphical instructions. It is to be appreciated that block 260 (FIG. 5) covers the packaging of multiple images for animation purposes.

As shown in block 630, the method includes transmitting the service solution data 260 to the mobile device 200 for review by the mechanic 190.

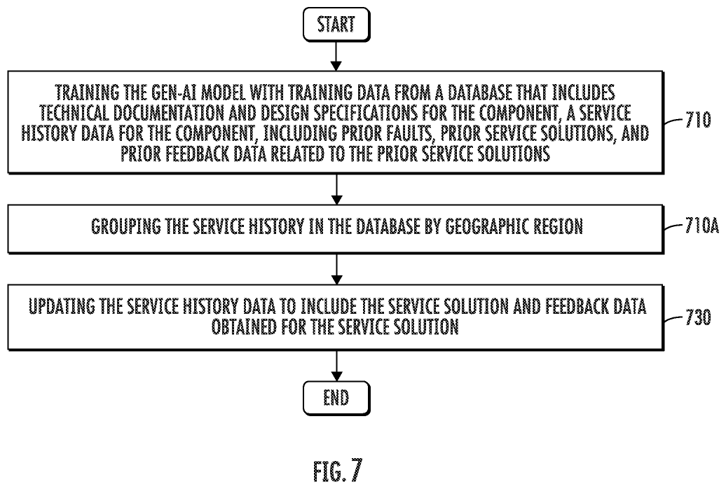

As shown in FIG. 7, a flowchart shows a method of training a Gen-AI architecture 250 to provide guided service solutions to address elevator component faults. As shown in block 710 the method includes training the Gen-AI architecture 250 with training data 252 from a database 255 that includes technical documentation and design specifications for the component. The database 255 also includes a service history data for the component, including prior faults, prior service solutions and prior feedback data related to the prior service solutions. As shown in block 710A, training the Gen-AI architecture 250 (block 710) further includes grouping the service history in the database 255 by geographic region. As shown in block 720, after execution of the Gen-AI architecture 250 to identify the service solution, the method includes updating the service history data to include the service solution and feedback data 289 obtained for the service solution, which is then used to further improve the model and future solutions.

As identified herein an architecture provides working parameters—such as the number, size, and type of layers in a neural network. Models may represent a portion of an architecture; an instance that trains on a chosen set of data. For example, in a neural net, the trained weights of each node, per the architecture, may constitute the model. Generative AI is a type of artificial intelligence that can learn from existing artifacts to generate new, realistic artifacts (at scale) that reflect the characteristics of the training data. It can produce a variety of novel content, such as images, video, music, speech, text, software code and product designs. Generative AI models learn the patterns and structure of their input training data and then generate new data that has similar characteristics. A diffusion model is a class of latent variable models that are trained using variational inference. Diffusion models learn the latent structure of a dataset by modeling the way in which data points diffuse through the latent space. Diffusion models can be applied to a variety of tasks, including image denoising, inpainting, super-resolution, and image generation. An encoder is a neural network that transforms the input data into a lower dimensional representation. A decoder is a neural network that reconstructs the input data from the lower dimensional representation. Together, encoders and decoders are used for dimensionality reduction and feature extraction from data.

Sensor data identified herein may be obtained and processed separately, or simultaneously and stitched together, or a combination thereof, and may be processed in a raw or complied form. The sensor data may be processed on the sensor (e.g. via edge computing), by controllers identified or implicated herein, on a cloud service, or by a combination of one or more of these computing systems. The sensor may communicate the data via wired or wireless transmission lines, applying one or more protocols as indicated below.

Wireless connections may apply protocols that include local area network (LAN, or WLAN for wireless LAN) protocols. LAN protocols include WiFi technology, based on the Section 802.11 standards from the Institute of Electrical and Electronics Engineers (IEEE). Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. LAN and WAN protocols may be generally considered TCP/IP protocols (transmission control protocol/Internet protocol), used to govern the connection of computer systems to the Internet. Wireless connections may also apply protocols that include private area network (PAN) protocols. PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Wireless connections may also include radio-frequency identification (RFID) technology, used for communicating with an integrated chip (IC), e.g., on an RFID smartcard. In addition, Sub-1 Ghz RF equipment operates in the ISM (industrial, scientific and medical) spectrum bands below Sub 1 Ghz-typically in the 769-935 MHz, 315 Mhz and the 468 Mhz frequency range. This spectrum band below 1 Ghz is particularly useful for RF IOT (internet of things) applications. The Internet of things (IoT) describes the network of physical objects—“things”—that are embedded with sensors, software, and other technologies for the purpose of connecting and exchanging data with other devices and systems over the Internet. Other LPWAN-IOT technologies include narrowband internet of things (NB-IOT) and Category M1 internet of things (Cat M1-IOT). Wireless communications for the disclosed systems may include cellular, e.g. 2G/3G/4G (etc.). Other wireless platforms based on RFID technologies include Near-Field-Communication (NFC), which is a set of communication protocols for low-speed communications, e.g., to exchange date between electronic devices over a short distance. NFC standards are defined by the ISO/IEC (defined below), the NFC Forum and the GSMA (Global System for Mobile Communications) group. The above is not intended on limiting the scope of applicable wireless technologies.

Wired connections may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a master/slave protocol designed for use with its programmable logic controllers (PLCs) and which is a commonly of connecting available means industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

When data is transmitted over a network between end processors as identified herein, the data may be transmitted in raw form or may be processed in whole or part at any one of the end processors or an intermediate processor, e.g., at a cloud service (e.g. where at least a portion of the transmission path is wireless) or other processor. The data may be parsed at any one of the processors, partially or completely processed or complied, and may then be stitched together or maintained as separate packets of information. Each processor or controller identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random access memory (RAM), read only memory (ROM), or other electronic, optical, magnetic or any other computer readable medium.

The controller may further include, in addition to a processor and non-volatile memory, one or more input and/or output (I/O) device interface(s) that are communicatively coupled via an onboard (local) interface to communicate among other devices. The onboard interface may include, for example but not limited to, an onboard system bus, including a control bus (for inter-device communications), an address bus (for physical addressing) and a data bus (for transferring data). That is, the system bus may enable the electronic communications between the processor, memory and I/O connections. The I/O connections may also include wired connections and/or wireless connections identified herein. The onboard interface may have additional elements, which are omitted for simplicity, such as controllers, buffers (caches), drivers, repeaters, and receivers to enable electronic communications. The memory may execute programs, access data, or lookup charts, or a combination of each, in furtherance of its processing, all of which may be stored in advance or received during execution of its processes by other computing devices, e.g., via a cloud service or other network connection identified herein with other processors.

Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An system for moving people, comprising:
a component; and
a processor configured to:
receive a diagnostic message from a mobile device identifying a fault with the component; and
execute a generative artificial intelligence (Gen-AI) model that identifies the component, the fault and generates service solution data for performing a service solution for addressing the fault for the component; and
transmit the service solution data to the mobile device.

2. The system of claim 1, wherein the component is an elevator car, an elevator machine, an escalator, or a moving walkway.

3. The system of claim 1, wherein:
the Gen-AI architecture is configured to identify the component from pairwise mapping of an image and text encoder matrix generated by applying component image descriptions to a text encoder of the Gen-AI architecture and applying component images to an image encoder of the Gen-AI architecture.

4. The system of claim 1, wherein:
the diagnostic message includes a textual description of symptoms of the fault; and
the Gen-AI architecture includes an encoder that extracts the component and the fault from the textual description.

5. The system of claim 4, wherein:
the service solution data includes textual instructions and corresponding graphical instructions for performing the service solution.

6. The system of claim 5, wherein:
the textual instructions includes a sequence of steps and the graphical instructions illustrate the sequence of steps as one or more of an image and an animation for performing each step in the sequence of steps.

7. The system of claim 6, wherein the graphical instructions illustrate the sequence of steps as 3-D animations for performing each of the sequence of steps.

8. The system of claim 5, wherein:
the Gen-AI architecture is configured to apply a text-to-text model to generate the textual instructions and apply a text-to-image model to generate the graphical instructions.

9. The system of claim 5, wherein:
the processor is configured to train the Gen-AI architecture with training data from a database that includes:
technical documentation and design specifications for the component;
a service history data for the component, including prior faults and prior service solutions; and
prior feedback data related to the prior service solutions,
wherein after execution of the Gen-AI architecture to identify the service solution, the service history data is updated to include the service solution and feedback data for the service solution.

10. The system of claim 9, wherein the service history data in the database grouped by geographic region.

11. A method of addressing a fault of a component in a system for moving people, comprising:
receiving a diagnostic message, from a mobile device, identifying the fault with the component; and
executing a generative artificial intelligence (Gen-AI) model that identifies the component, the fault and generates service solution data for performing a service solution for addressing the fault for the component; and
transmitting the service solution data to the mobile device.

12. The method of claim 11, wherein the component is an elevator car, an elevator machine, an escalator, or a moving walkway.

13. The method of claim 11, including:
identifying the component from pairwise mapping of an image and text encoder matrix generated by applying component image descriptions to a text encoder of the Gen-AI architecture and applying component images to an image encoder of the Gen-AI architecture.

14. The method of claim 11, wherein:
the diagnostic message includes a textual description of symptoms of the fault; and
the method includes the Gen-AI architecture, extracting with an encoder, the component and the fault from the textual description within the diagnostic message.

15. The method of claim 14, comprising:
including, in the service solution data, textual instructions and corresponding graphical instructions for performing the service solution.

16. The method of claim 15, wherein:
the textual instructions includes a sequence of steps; and
the method includes providing, with the graphical instructions, one or more of an image and an animation for performing each step in the sequence of steps.

17. The method of claim 16, wherein the method includes providing, with the graphical instructions, 3-D animations for performing each of the sequence of steps.

18. The method of claim 15, comprising:
applying, by the Gen-AI architecture, a text-to-text model to generate the textual instructions and a text-to-image model to generate the graphical instructions.

19. The method of claim 15, comprising:
training the Gen-AI architecture with training data from a database that includes:
technical documentation and design specifications for the component;
a service history data for the component, including prior faults and prior service solutions; and
prior feedback data related to the prior service solutions,
wherein after execution of the Gen-AI architecture to identify the service solution, the method includes updating the service history data to include the service solution and feedback data for the service solution.

20. The method of claim 19, comprising grouping the service history data in the database by geographic region.
